(19) United States
(12) Patent Application Publication
(10) Pub. No.: US 2024/0037345 A1
(43) Pub. Date: Feb. 1, 2024

(54) SYSTEM AND METHOD FOR ARTIFICIAL INTELLIGENCE CLEANING TRANSFORM

(71) Applicant: Yext, Inc., New York, NY (US)

(72) Inventors: Jamie O'Brien, New York, NY (US); Maxwell Shaw, New York, NY (US); Michael Misiewicz, Brooklyn, NY (US); Pierce Stegman, Falls Church, VA (US); Andrew Lauria, New York, NY (US); Vinay Ramkrishnan, Hoboken, NJ (US); Amichai Z. Berman, New York, NY (US); Steven Sanshwe, Brooklyn, NY (US); Diana Keung, New York, NY (US); Jesse Sharps, Brooklyn, NY (US); Jesse Shatsky, Brooklyn, NY (US); Rachel Adler, New York, NY (US)

(73) Assignee: Yext, Inc., New York, NY (US)

(21) Appl. No.: 17/815,786

(22) Filed: Jul. 28, 2022

(51) Int. Cl. G06F 40/40; G06F 40/226; G06F 40/103

(52) U.S. Cl. CPC G06F 40/40; G06F 40/226; G06F 40/103

(57) ABSTRACT

Systems, methods, and computer-readable storage media for receiving data at a computer system, wherein the data has a plurality of rows; receiving, from a user at the computer system, a description of a task associated with the data; receiving, from the user at the computer system, a plurality of example transformations; combining, via at least one processor of the computer system, the task description together with the plurality of example transformations and input and output labels, resulting in a prompt; executing, via the at least one processor, a machine learning model, wherein the prompt is an input to the machine learning model, and wherein output of the machine learning model comprises an algorithm for executing the task; and executing, via the at least one processor, the task on the data using the algorithm.

### BACKGROUND

### 1. Technical Field

The present disclosure relates to a machine learning process for cleaning of data, and more specifically to modifying data based on a limited set of examples using Artificial Intelligence.

### 2. Introduction

Knowledge graphs, also known as semantic networks, represent connections between real-world entities, such as objects, events, situations, or concepts, by illustrating the relationship between them. This information is usually stored in a graph database and visualized as a graph structure, prompting the term knowledge “graph.” Knowledge graphs have three main components: nodes, edges, and labels. Any object, place, or person can be a node, which is identified with a label. An edge defines the relationship between the nodes.

In order for a knowledge graph to accurately represent the real-world relationships between nodes, the data used to construct the knowledge graph needs to be consistently formatted.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving data at a computer system, wherein the data has a plurality of rows; receiving, from a user at the computer system, a description of a task associated with the data; receiving, from the user at the computer system, a plurality of example transformations, and input and output labels; combining, via at least one processor of the computer system, the task description together with the plurality of example transformations and input and output labels, resulting in a prompt; executing, via the at least one processor, a machine learning model, wherein the prompt is an input to the machine learning model, and wherein output of the machine learning model comprises an algorithm for executing the task; and executing, via the at least one processor, the task on the data using the algorithm.

A system configured to perform the concepts disclosed herein can include: at least one processor; and a non-transitory computer-readable storage medium having instructions stored which, when executed by the at least one processor, cause the at least one processor to perform operations comprising: receiving data, wherein the data has a plurality of rows; receiving, from a user, a description of a task associated with the data; receiving, from the user, a plurality of example transformations; combining the task description together with the plurality of example transformations, resulting in a prompt; executing a machine learning model, wherein the prompt is an input to the machine learning model, and wherein output of the machine learning model comprises an algorithm for executing the task; and executing the task on the data using the algorithm.

A non-transitory computer-readable storage medium configured as disclosed herein can have instructions stored which, when executed by a computing device, cause the computing device to perform operations which include: receiving data, wherein the data has a plurality of rows; receiving, from a user, a description of a task associated with the data; receiving, from the user, a plurality of example transformations; combining the task description together with the plurality of example transformations, resulting in a prompt; executing a machine learning model, wherein the prompt is an input to the machine learning model, and wherein output of the machine learning model comprises an algorithm for executing the task; and executing the task on the data using the algorithm.

### BRIEF DESCRIPTION OF THE DRAWINGS

FIG. 1 illustrates an example system embodiment;

FIG. 1A illustrates an example of connector sources;

FIG. 2 illustrates an example of a transform user interface;

FIG. 3 illustrates first examples of transform inputs and outputs;

FIG. 4 illustrates second examples of transform inputs and outputs;

FIG. 5 illustrates an example process for data transformation;

FIG. 6 illustrates an example method embodiment; and

FIG. 7 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

Systems configured as disclosed herein obtain, clean, and transform data. The cleaned and transformed data may then be used for various purposes, such as input into a knowledge graph. In some embodiments, the data from the knowledge graph may be further utilized, for example, in web page creation, publications, etc. Exemplary, non-limiting sources of the data can a web crawler, API (Application Programming Interface) requests, webhooks (a method of augmenting or altering the behavior of a web page or web application with custom callbacks, operating, for example, via a “Push to API” source option), and custom typescript functions. The system may determine one or more data sources. The data sources may be configured by a user. The system disclosed herein can then obtain the source data and perform transformations (“transforms”) on the source data, thereby cleaning the data, at which point the clean data can be loaded into a knowledge graph, or used in another manner.

In one example, a machine learning model may be used to transform or clean the data. “Few-shot data cleaning” is a broad class of applications that involve transforming or modifying text data given very few examples (hence the term, “few-shot”). Generally, “few examples” means “fewer than about ten.” For example, a model may be given three examples where lower-case text is converted to upper-case text (e.g., “a” to “A”). The model learns the transform given only the three examples. The model can then apply this transformation to any arbitrary text. Transformation tasks are also often accompanied by a short description of the task, for example, “Convert each piece of text to upper-case.” The model being trained in this manner can be any machine learning model configured to operate in this manner. Non-limiting examples of machine learning models capable of operating in this manner include autoregressive language models using a transformer network for language prediction, such as the Generative Pre-trained Transformer 3 (GPT-3) model.

Consider the following example. On a retailer product page of a website, the product price is listed as “From $449 or $18.70/mo. per month for 24 mo.” The full price is to be extracted from the website and stored in a price field of a knowledge graph. The required format for “price” in the knowledge graph may be “USD 449.00”. The system allows the user to set up a single transform, resulting in the system extracting and converting the “From $449 or $18.70/mo. per month for 24 mo.” listing into “USD 449.00”. The system can use the transform to do the same for other websites or webpages which have a similar data structure, without needing to be retrained. To do this, the system uses a “Data Cleaning Transform,” where the system is provided with a few examples of the data cleaning to perform, then applies the same pattern to an entire column of data, automatically cleaning the data according to the defined transform.

The system may provide the option to create a new transform when configuring the system to import data (regardless of data source). In this option, examples of inputs and expected outputs are provided. The particular data within the imported data, for example a column of data, containing the data to be cleaned is identified, and the system performs the data transform. The data may be specified by a user or automatically identified by the system. An exemplary work flow may be:
A data source is selected and any source-specific configuration obtained;
Instruction to add a transform is received;
The inputs for the transform are presented:

The column that contains the data on which to perform the transform;

Text description of the transform (i.e. Task Description);

A few example inputs and corresponding expected outputs for the transform:
e.g. Input: “From $449 or $18.70/mo. per month for 24 mo.*”, Output: “USD 449.00”
e.g. Input: “From $399 or $16.62/mo. per month for 24 mo.*”, Output: “USD 399.00”
e.g. Input: “From $799 or $33.29/mo. per month for 24 mo.*”, Output: “USD 799.00”

And, in exemplary embodiments, input and output labels for the transform:
e.g. input label: “Product URL”;
e.g. output label: “Product category”;
   The system creates a prompt using the text description and the example inputs/outputs;
   The prompt is input into a model which outputs computer instructions for how to perform the transform;
   User clicks “Apply” to apply the transform;
   The system executes the transform for each cell in the specified column, transforming a copy of the data into cleaned data; and
   The system replaces the original cell content (i.e., the original data within the selected column) with the cleaned data

In some configurations, the system can provide a preview option, where the transform may be tested on a subset of data, before applying the transform to all data. Likewise, in some configurations the transform can be applied to the data within the knowledge graph database.

Obtaining the data can be done via different mechanisms. In some cases the system can use APIs or crawl websites and extract HTML (HyperText Markup Language). While in some cases the JSON (JavaScript Object Notation) and HTML extracted from the website can be well structured (and not need cleaning), often the data will need additional cleansing, parsing, or formatting in order to match the expected field formats, for example, of a knowledge graph (such as formatting of dates/times/etc.). The system disclosed herein can significantly speed up and improve the current computer process of cleaning and transforming the data, allowing the extracted data to be transformed into a desired format easily and more flexibly, using natural language instructions.

Non-limiting examples of sources for data can include a web-site/web-page crawler; YOUTUBE, VIMEO, or other video storage/distribution websites; TWITTER, FACEBOOK, INSTAGRAM, LINKEDIN, TIK-TOK, or other social media platforms; and platforms such as ZENDESK, HUBSPOT, GURU, CONFLUENCE, GREENHOUSE, and DRUPAL. The ability to select a source of data and add that data to a knowledge graph may be referred to as a “connector.”

The description next turns to the specific examples provided by the figures.

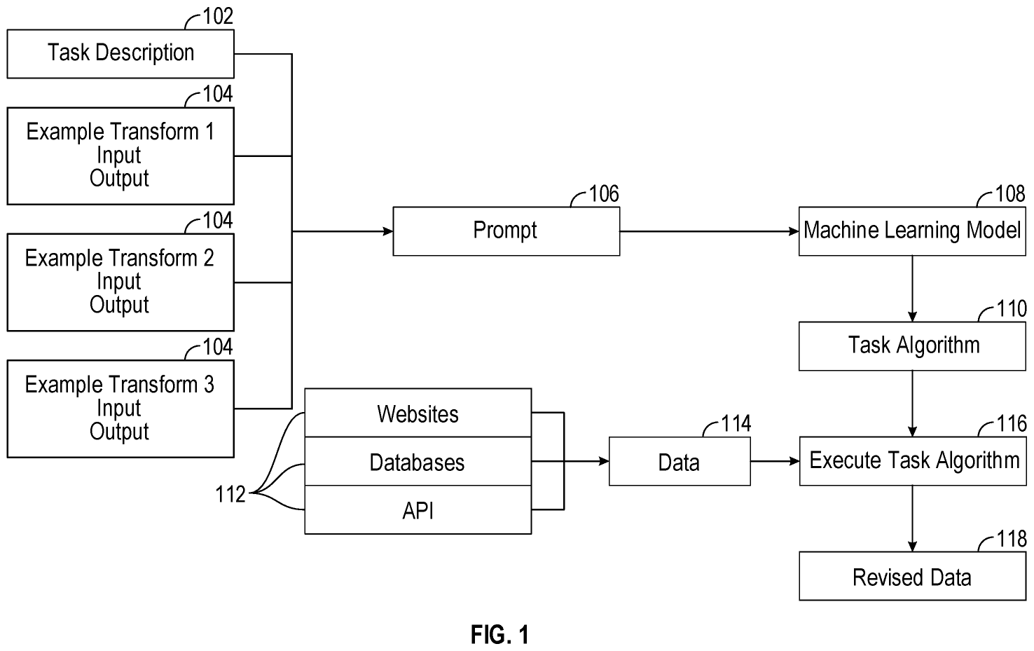

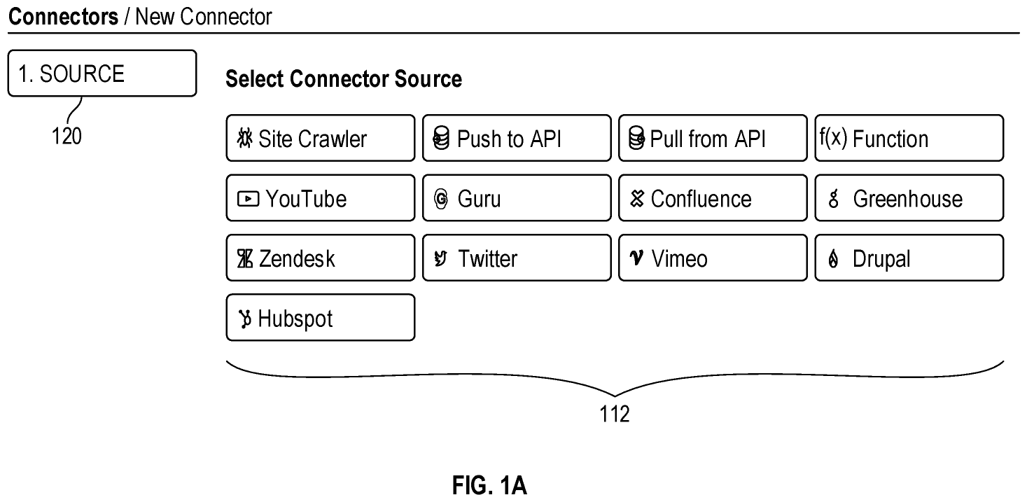

FIG. 1 illustrates an example system embodiment. In this example, a task is to be executed on a collection of data 114. A task description 102, as well as examples 104 of how the data should be transformed by the task, are received by the system. The task may be provided by a user. If, for example, the first letter of each piece of data should be capitalized, the task description 102 could be “Capitalize first word,” and an example of the transform could be {Input: “apple”; Output: “Apple}. Preferably there are multiple examples 104 of the transform (illustrated are three examples 104; there can be fewer or more examples 104 as needed). While the system can use additional examples, preferably the number of examples 104 is less than ten.

In some embodiments input and output labels may be utilized. The input and output labels may be a short text description that describes the input and output data, respectively. For example an input label may be “Product URL” and an output label may be “Product Category.”

Using the task description 102, input and output labels, and the example transforms 104, the system creates a prompt 106. In some configurations, the created prompt 106 is a string aggregation of the task description 102, input and output labels, and the example transforms 104. In other configurations, the created prompt 106 is reduced or formatted prior to aggregation. The resulting prompt 106 is input into a machine learning model 108, which performs natural language processing on the prompt 106, parsing out the task description 102 and the examples 104, with the output being a task algorithm 110. The task algorithm 110 represents the model's 108 attempt to use the description 102 of the task description and the examples 104 to perform the described task 102. The system then retrieves data 114 from one or more sources 112, such as websites, databases, and API feeds. The task algorithm 110, when executed 116 using the data 114, modifies and cleans the data, resulting in revised data 118.

FIG. 1A illustrates an example of connector sources 112. These may be sources of data 112 which can be mined or otherwise used to obtain data to be transformed, for example, for use in a knowledge graph. However, these data sources may provide unformatted, unstructured, or otherwise “unclean” data which needs to be formatted prior to further processing or use, such as entry into the knowledge graph. The user, in operating the system, can select 120 from one or more of the sources 112 illustrated.

In one example, embodiments of the invention may be integrated into ETL (Extract, Transform, Load) system. ETL systems are tools used to transfer data from one source to another. FIG. 1A illustrates a variety of sources from which data can be pulled into a knowledge graph. The transform may require sample inputs, outputs, and a task description that may be used to train a model. This model is then applied to the ingested data, in order to clean data to then be sent to knowledge graph. The knowledge graph may include fields for storing data. The data may be mapped to the fields to be stored in the knowledge graph. Cleaning the data places the data in the proper format for the appropriate field in the knowledge graph.

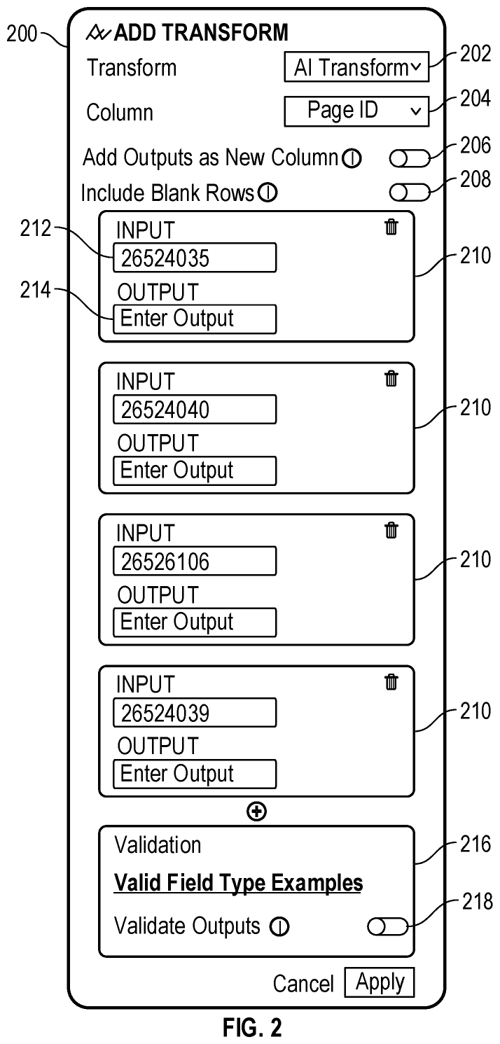

FIG. 2 illustrates an example of a transform user interface 200. In this example, an option to select a transform to be performed on the selected data, for example from one or more of the data sources in FIG. 1A, is provided. Here, the desired transform 202 is “AI Transform.” In some configurations, the user can select the text description 202 of the transform from a drop-down list, whereas in other configurations the user can type in or otherwise provide their own description for the transform. In this example, the user can also select (1) the column 204 or type of data to be transformed; (2) the ability to add outputs of the transform as a new column 206 (or, if not selected, to overwrite the data being transformed); and (3) to include blank rows 208 in the transformation. In other configurations the system may be such that one or more of these options 204, 206, 208 are not presented to the user.

The illustrated transform user interface 200 also allows the user to input example transforms 210 that the system uses to form the transformation algorithm. In each example transform 210 an example input 212 and an example output 214 may be received, where the example output 214 is the output the user would like to see if the example input 210 were transformed. In some embodiments, the task description, input label, output label, and three example inputs and output are needed. The user interface 200 can also contain a validation portion 216, which provides the user the option to validate outputs 218 prior to accepting the transformation outputs as “clean” and/or prior to adding the outputs to a knowledge graph. Once the inputs are finalized, the “Apply” button may be selected to start the process, for example as described above. In exemplary embodiments, to start the process, which includes transforming data included in the preview table, all data has the transform applied when the model is run to process the data to be sent to the knowledge graph

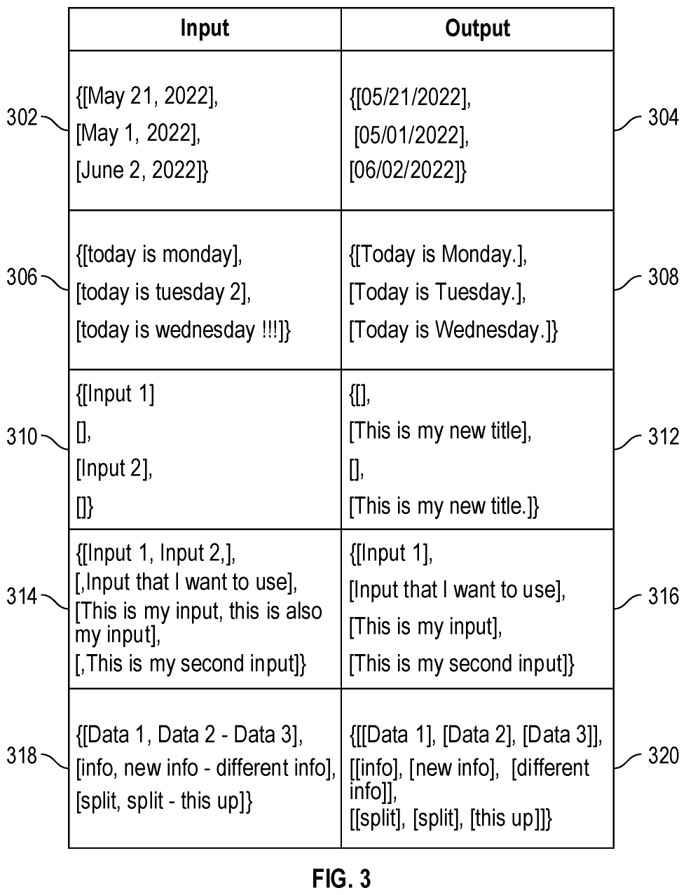

FIG. 3 illustrates first examples of transforms of data inputs and outputs. In this example, the first row 302, 304 illustrates examples of date formatting. The example inputs 302 correspond to dates, such as “May 21, 2022” and an exemplary output may be “05/21/2022,” thereby providing an example of how the transform is to modify the data. The next row 306, 308 illustrates an example of both capitalization and removing additional information. In this example, the inputs 306 have lower case letters to start the phrase (e.g., “today”), lower case day names (e.g., “monday”, “tuesday”), and in some case additional punctuation (e.g., “!!!”) or numbers (e.g., “2”). The example outputs provided by the user capitalize the first letters of the first words of each exemplary input (e.g., “Today”), capitalize the day names (e.g., “Monday”), and remove any additional characters after the day name.

In the third row 310, 312, the exemplary inputs 310 and outputs 312 appear to indicate that any brackets “[ ]” with text between the brackets (e.g., “[Input 1]”) results in an empty bracket (e.g., In being returned, whereas an empty bracket results in “[This is my new title]” being returned.

In the fourth row 314, 316, the exemplary inputs 314 and outputs 316 illustrate the ability of the system to form more complex, conditional transforms. In this example 314, 316, if an input has text before a comma, that pre-comma text is the output. If there is no text before a comma, the text after the comma becomes the output.

In the fifth and final row 318, 320, the exemplary inputs 318 and outputs 320 illustrate the ability to insert brackets around each different point of data, effectively parsing the data from a string into individual components which are ready for additional analysis, manipulation, or entry into the knowledge graph.

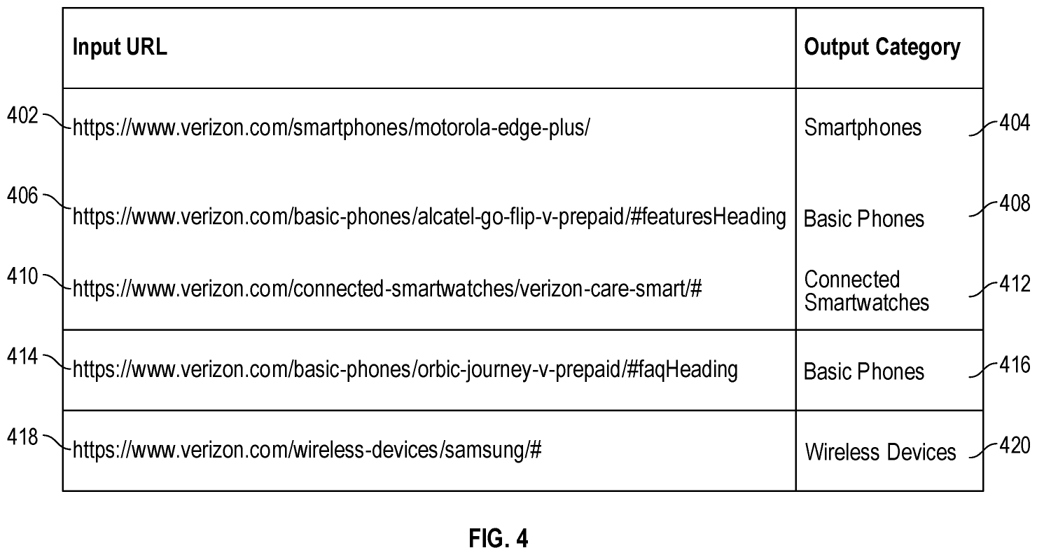

FIG. 4 illustrates second examples of transform inputs and outputs. Here, the source data may be URLs. The desired output may be to determine to which product category the URL is referring. The task provided to the system thus may be to “find the product category given the URL”. URLs 402, 406, 410, 414, and 418 each refer to a product category within the URL: smartphones; basic-phones; connected-smartwatches; basic-phones; and wireless-devices, respectively. Given the task, example inputs, and example outputs, the model can generate outputs, or tokens. Examples of the output categories to be generated by the model are shown as 404, 408, 412, 416, and 420 in FIG. 4.

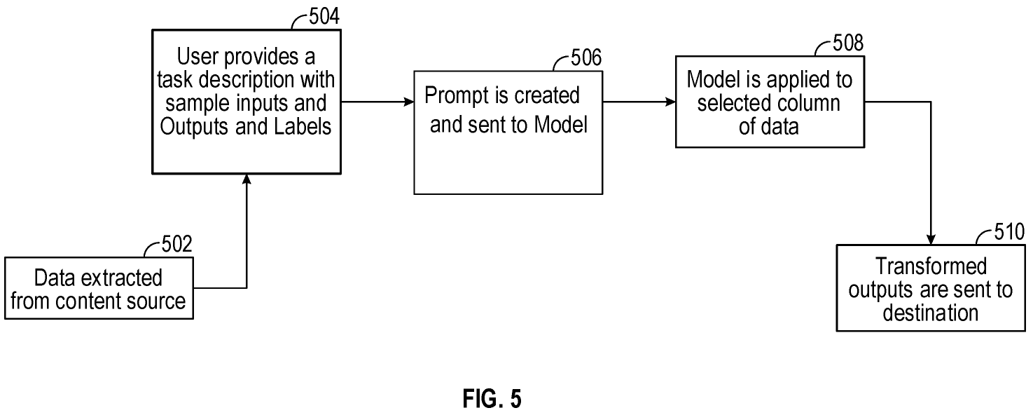

FIG. 5 illustrates an example process for data transformation. Per box 502, data may be extracted from the content source. The content source may be any number of data sources, as noted above in connection with FIG. 1A. Although box 502 is shown as an input to box 504, this is not necessarily the case. The data may be extracted prior to, in parallel with or after box 504. Turning to box 504, information for creating a prompt for the machine learning model is received. The prompt may include a task, example input, example output, and input and output labels. This information may be received via a user interface, for example as shown in FIG. 2. In some scenarios, pre-constructed prompts for common tasks may be developed and then stored in the system. For example, a database of known prompts that are suitable for given tasks may be created. The pre-constructed prompts may be for common types of data and transformation, such as dates, prices, etc. The preconstructed prompts may include the common output format and task description for the data type. These transforms may be provided for selection via a menu or the like, for example as an option in the pull down menu 202 in FIG. 2.

Per box 506, the prompt may be created and customized for each task, and sent to the model. The model utilizes the prompt for the transformation, for example as described in connection with FIG. 1. The model may be a generative model that generates words based on the prompt. For example, the model may be a language predictive model that uses advanced machine learning to generate human-like text. For example, based on the prompt, the model may generate a biography based on the input of certain facts; generate a description based on the input of certain information; generate a translation of certain information; and/or generate a review response based on a review. In other embodiments, the model may convert unstructured data to semi-structured or structured data (e.g., generate FAQs from description, etc.). The available outs can vary based on the use case, and available data.

The model is applied to the selected data, per box 508. In this example, the selected data is a column of data extracted from the data source. The model may be called for each cell in the column to transform the data in that column. In some examples, the model may be retrained between uses or iterations. For example, the model may be retrained based on the results generated after some of or each of the data in the cells in the column is transformed, or after the entire column is processed, etc. The extracted may be in spreadsheet format, e.g. in columns and rows, but may be in other formats also. Thus, different data may be designated for transformation, such as one or more rows or columns, or different data fields from the extracted data.

Per box 510, the transformed data outputs are provided to the destination. In the described embodiment, the destination is a knowledge graph, and the data is loaded into the knowledge graph. However, other output destinations are also contemplated. Another example may be to provide an answer to frequently asked questions. The transform may intake a question, generate a prompt based on the question, and generate content for the response as the output. The generated response may or may not include information that appeared in the prompt. In additional examples, the transform may generate a biography based on the input of certain facts; generate a description based on the input of certain information; generate a translation of certain information; and/or generate a review response based on a review.

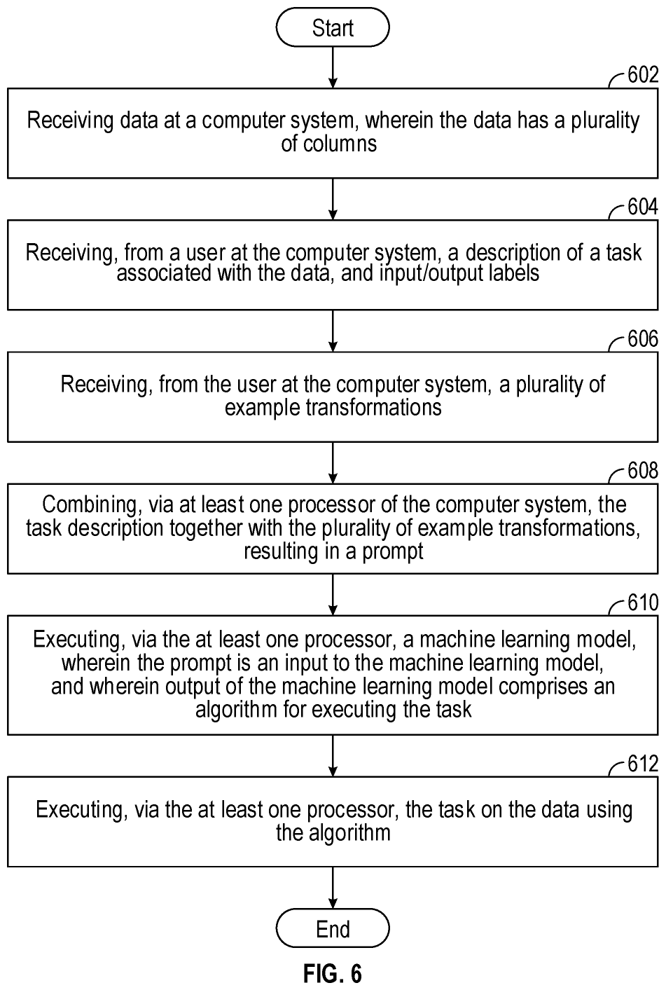

FIG. 6 illustrates an example method embodiment. As illustrated, the method can include receiving data at a computer system, wherein the data has a plurality of columns (602), and receiving, from a user at the computer system, a description of a task associated with the data, and input and output labels (604). The method can then include receiving, from the user at the computer system, a plurality of example transformations (606). Via at least one processor of the computer system, the task description, and input and output labels may be together with the plurality of example transformations, resulting in a prompt (608). In some embodiments, the systems may be configured such that one or more of the received data may be omitted. The method can next include executing, via the at least one processor, a machine learning model, wherein the prompt is an input to the machine learning model, and wherein output of the machine learning model comprises an algorithm for executing the task (610), and executing, via the at least one processor, the task on the data using the algorithm (612).

In some configurations, the plurality of example transformations can include: an input for a transformation; and an output for the transformation.

In some configurations, the plurality of example transformations number three.

In some configurations, the description of the task is prose. In such configurations, the illustrated method can further include executing, via the at least one processor, natural language processing (NLP) on the description of the task, resulting in parsed text, wherein the prompt further comprises the parsed text.

In some configurations, the illustrated method can further include receiving, at the computer system, feedback regarding accuracy of the execution of the task on the data using the algorithm; and retraining, via the at least one processor, the machine learning model using the feedback.

In some configurations, the machine learning model is a GPT-3 (Generative Pre-trained Transformer 3) model.

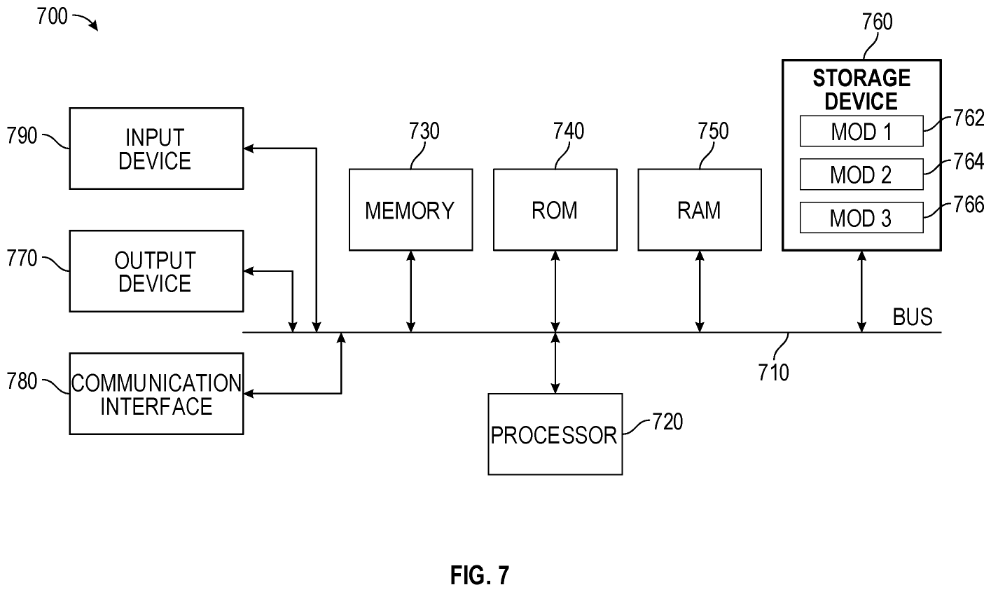

With reference to FIG. 7, an exemplary system includes a general-purpose computing device 700, including a processing unit (CPU or processor) 720 and a system bus 710 that couples various system components including the system memory 730 such as read-only memory (ROM) 740 and random-access memory (RAM) 750 to the processor 720. The system 700 can include a cache of high-speed memory connected directly with, in close proximity to, or integrated as part of the processor 720. The system 700 copies data from the memory 730 and/or the storage device 760 to the cache for quick access by the processor 720. In this way, the cache provides a performance boost that avoids processor 720 delays while waiting for data. These and other modules can control or be configured to control the processor 720 to perform various actions. Other system memory 730 may be available for use as well. The memory 730 can include multiple different types of memory with different performance characteristics. It can be appreciated that the disclosure may operate on a computing device 700 with more than one processor 720 or on a group or cluster of computing devices networked together to provide greater processing capability. The processor 720 can include any general-purpose processor and a hardware module or software module, such as module 1 762, module 2 764, and module 3 766 stored in storage device 760, configured to control the processor 720 as well as a special-purpose processor where software instructions are incorporated into the actual processor design. The processor 720 may essentially be a completely self-contained computing system, containing multiple cores or processors, a bus, memory controller, cache, etc. A multi-core processor may be symmetric or asymmetric.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up. The computing device 700 further includes storage devices 760 such as a hard disk drive, a magnetic disk drive, an optical disk drive, tape drive or the like. The storage device 760 can include software modules 762, 764, 766 for controlling the processor 720. Other hardware or software modules are contemplated. The storage device 760 is connected to the system bus 710 by a drive interface. The drives and the associated computer-readable storage media provide nonvolatile storage of computer-readable instructions, data structures, program modules and other data for the computing device 700. In one aspect, a hardware module that performs a particular function includes the software component stored in a tangible computer-readable storage medium in connection with the necessary hardware components, such as the processor 720, bus 710, display 770, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the device 700 is a small, handheld computing device, a desktop computer, or a computer server.

Although the exemplary embodiment described herein employs the hard disk 760, other types of computer-readable media which can store data that are accessible by a computer, such as magnetic cassettes, flash memory cards, digital versatile disks, cartridges, random access memories (RAMs) 750, and read-only memory (ROM) 740, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 700, an input device 790 represents any number of input mechanisms, such as a microphone for speech, a touch-sensitive screen for gesture or graphical input, keyboard, mouse, motion input, speech and so forth. An output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

We claim:

1. A method comprising:
receiving data at a computer system, wherein the data has a plurality of rows;
receiving, from a user at the computer system, a description of a task associated with the data;
receiving, from the user at the computer system, a plurality of example transformations;
receiving, from the user at the computer system, input and output labels;
combining, via at least one processor of the computer system, the task description together with the plurality of example transformations and input and output labels, resulting in a prompt;
executing, via the at least one processor, a machine learning model, wherein the prompt is an input to the machine learning model, and wherein output of the machine learning model comprises an algorithm for executing the task; and
executing, via the at least one processor, the task on the data using the algorithm.

2. The method of claim 1, wherein the plurality of example transformations comprise:
an input for a transformation; and
an output for the transformation.

3. The method of claim 1, wherein the plurality of example transformations number three.

4. The method of claim 1, wherein the description of the task is prose.

5. The method of claim 4, further comprising:
executing, via the at least one processor, natural language processing (NLP) on the description of the task, resulting in parsed text,
wherein the prompt further comprises the parsed text.

6. The method of claim 1, further comprising:
receiving, at the computer system, feedback regarding accuracy of the execution of the task on the data using the algorithm; and
retraining, via the at least one processor, the machine learning model using the feedback.

7. The method of claim 1, wherein the machine learning model is a GPT-3 (Generative Pre-trained Transformer 3) model.

8. A system comprising:
at least one processor; and
a non-transitory computer-readable storage medium having instructions stored which, when executed by the at least one processor, cause the at least one processor to perform operations comprising:
receiving data, wherein the data has a plurality of rows;
receiving a description of a task associated with the data;
receiving a plurality of example transformations;
receiving input and output labels;
combining the task description together with the plurality of example transformations and input and output labels, resulting in a prompt;
executing a machine learning model, wherein the prompt is an input to the machine learning model, and wherein output of the machine learning model comprises an algorithm for executing the task; and
executing the task on the data using the algorithm.

9. The system of claim 8, wherein the plurality of example transformations comprise:
an input for a transformation; and
an output for the transformation.

10. The system of claim 8, wherein the plurality of example transformations number three.

11. The system of claim 8, wherein the description of the task is prose.

12. The system of claim 11, the non-transitory computer-readable storage medium having additional instructions stored which, when executed by the at least one processor, cause the at least one processor to perform operations comprising:
executing, via the at least one processor, natural language processing (NLP) on the description of the task, resulting in parsed text,
wherein the prompt further comprises the parsed text.

13. The system of claim 8, the non-transitory computer-readable storage medium having additional instructions stored which, when executed by the at least one processor, cause the at least one processor to perform operations comprising:
receiving feedback regarding accuracy of the execution of the task on the data using the algorithm; and
retraining the machine learning model using the feedback.

14. The system of claim 8, wherein the machine learning model is a GPT-3 (Generative Pre-trained Transformer 3) model.

15. A non-transitory computer-readable storage medium having instructions stored which, when executed by at least one processor, cause the at least one processor to perform operations comprising:
receiving data, wherein the data has a plurality of rows;
receiving a description of a task associated with the data;
receiving a plurality of example transformations;
receiving input and output labels;
combining the task description together with the plurality of example transformations and input and output labels, resulting in a prompt;
executing a machine learning model, wherein the prompt is an input to the machine learning model, and wherein output of the machine learning model comprises an algorithm for executing the task; and
executing the task on the data using the algorithm.

16. The non-transitory computer-readable storage medium of claim 15, wherein the plurality of example transformations comprise:
an input for a transformation; and
an output for the transformation.

17. The non-transitory computer-readable storage medium of claim 15, wherein the plurality of example transformations number three.

18. The non-transitory computer-readable storage medium of claim 15, wherein the description of the task is prose.

19. The non-transitory computer-readable storage medium of claim 18, having additional instructions stored which, when executed by the at least one processor, cause the at least one processor to perform operations comprising:
executing, via the at least one processor, natural language processing (NLP) on the description of the task, resulting in parsed text,
wherein the prompt further comprises the parsed text.

20. The non-transitory computer-readable storage medium of claim 15, having additional instructions stored which, when executed by the at least one processor, cause the at least one processor to perform operations comprising:
receiving feedback regarding accuracy of the execution of the task on the data using the algorithm; and
retraining the machine learning model using the feedback.
